(19) United States
(12) Patent Application Publication
(10) Pub. No.: US 2026/0249946 A1
(43) Pub. Date: Aug. 27, 2026

(54) SYSTEM FOR A BICYCLE, BICYCLE, BALANCING ELEMENT, KIT, AND METHOD FOR CONNECTING TWO COMPONENTS FOR A BICYCLE

(71) Applicant: Porsche eBike Performance GmbH, Ottobrunn (DE)

(72) Inventors: Hans-Martin Noack, Deisenhofen (DE); Stefan Fischbacher, Schliersee (DE); Manuel Engelschall, Taufkirchen (VIls) (DE)

(21) Appl. No.: 19/551,405

(22) Filed: Feb. 26, 2026

(30) Foreign Application Priority Data
Feb. 26, 2025 (DE) 10 2025 107 258.2

(51) Int. Cl. B62K 19/40; B62M 6/40

(52) U.S. Cl. CPC B62K 19/40; B62M 6/40

(57) ABSTRACT

A system for a bicycle includes a first component and a second component that are connected to each other via a screw. The first component has a receptacle. The second component has a feedthrough. An insert with a hole is inserted into the receptacle of the first component. The screw is guided through the feedthrough in the second component into the hole in the insert. The screw is also screwed into an internal thread of an element other than the insert in the area of the first component. The insert has a lateral surface that extends around the hole. The insert is fixed axially in the receptacle via a force-fit and/or form-fit connection on its lateral surface.

### CROSS-REFERENCE TO RELATED APPLICATIONS

This application claims priority of German patent application no. 10 2025 107 258.2, filed February 26, 2025, the entire content of which is incorporated herein by reference.

### TECHNICAL FIELD

A system for a bicycle is specified. In addition, a bicycle, a balancing element, a kit, and a method for connecting two components for a bicycle are specified.

### BACKGROUND

Bicycles are cost-effective, easy-to-use, and emission-free means of transportation. They have also become popular as sports and fitness equipment, and types that are particularly suitable for different sporting activities have emerged. In recent years, enthusiasm for electric bicycles (especially so-called "pedelecs") has been growing, despite their high weight and price compared to conventional bicycles.

### SUMMARY

It is an object of the disclosure to provide a system for a bicycle with a stable connection between two components of the bicycle, in particular one in which wear in the area of the connection between the two components is reduced. Further objects include providing a bicycle with such a system, a compensating element for such a system, a kit for such a system, and the respective method for connecting two components for a bicycle.

These aforementioned objects are, for example, achieved via various embodiments of the disclosure.

First, the system for a bicycle is specified. In particular, the system is for an electric bicycle, for example a pedelec.

In at least one embodiment, the system for a bicycle includes a first component and a second component, which are connected to each other via a screw. The first component has a receptacle. The second component has a feedthrough. An insert with a hole is inserted into the receptacle of the first component. The screw is guided through the feedthrough in the second component into the hole in the insert. The screw is also screwed into an internal thread of the insert and/or an element other than the insert in the area of the first component. The insert has a lateral surface that extends around the hole. The insert is fixed axially in the receptacle via a force-fit and/or form-fit connection on its lateral surface.

To connect two components using a screw, a compensating element (also known as a tolerance compensating element) can be used to compensate for a tolerance in the axial distance between the two components. Such a compensating element can be a bushing that can be displaced in the axial direction. This is not fixed in the axial direction at the mounting point and is therefore movably mounted. Under load, such a bushing can move and generate noise. This can also lead to wear on the bushing and/or one of the two components.

In the present disclosure, an insert is used which is axially fixed in the receptacle via a force-fit and/or form-fit connection. Such an insert can also be used to create a spacer element, for example. The axial fixation reduces noise under load and wear due to movement.

In addition, the screw is screwed into an internal thread that is not assigned to the insert. The use of an insert and a separate internal thread increases the number of degrees of freedom for connecting the two components. This allows the insert used in the first component and the screw connection of the screw in the area of the first component to be optimized independently of each other. For example, the insert can then be made of a different material than the internal thread into which the screw is screwed in order to further optimize noise and/or motion suppression or for corrosion protection. The internal thread can be made of a particularly suitable material, such as stainless steel, for a secure screw connection with the screw. This makes the connection between the two components even more secure and convenient.

Alternatively, the internal thread can also be assigned to the insert.

The first component is, for example, a housing part of an electric motor for a bicycle and the second component is a frame section of the electric bicycle or vice versa. The first and/or second components are each made of metal, for example.

The first component and the second component can be offset from each other in the axial direction. For example, there is an axial gap between the first and second components. Here and in the following, the axial direction is a direction parallel to a z-axis. This z-axis is an axis through the feedthrough and through the receptacle. The z-axis is, for example, a longitudinal axis of the screw. The feedthrough and/or the receptacle are, for example, rotationally symmetrical about the z-axis. Furthermore, in the following, a radial direction is a direction perpendicular to the z-axis and through it. An azimuthal direction is, in the following, a direction perpendicular to the radial direction, perpendicular to the axial direction, and around the z-axis.

The receptacle in the first component is, for example, a borehole. The receptacle may completely penetrate the first component or merely be a recess that does not completely penetrate the first component. The feedthrough in the second component may be a borehole in the second component. The screw is passed through the feedthrough. In particular, the screw head of the screw is located on a different side of the second component than the insert.

The insert inserted into the receptacle is also referred to below as the "first insert." The insert is an element inserted or insertable into the receptacle. For example, the insert can be removed from the receptacle without damage after removing the screw.

The insert may be formed in one piece. The insert and/or the hole in the insert are, for example, formed rotationally symmetrical with respect to the z-axis. The insert is, for example, a cylindrical element. The insert includes a hole. The hole is, for example, a feedthrough through the insert or a recess in the insert that does not extend completely through the insert. The screw extends into the hole in the insert or through the hole. The hole may be cylindrical. For example, the insert is a sleeve. The insert may have an internal thread in the area of the hole or may be free of an internal thread there.

The lateral surface of the insert extends around the hole and around the screw inserted into it. For example, the lateral surface extends completely around the hole and the screw. The lateral surface is an outer surface of the insert. For example, it has the shape of a cylindrical lateral surface or is predominantly formed as a cylindrical lateral surface.

An existing gap between the first and second components can be bridged by the insert. For example, part of the insert protrudes from the receptacle. An end face of the insert that runs at an angle or perpendicular to the lateral surface can rest against the second component in the area around the feedthrough.

The screw is screwed into an internal thread in the area of the first component, for example, within the receptacle. The screw is fixed axially relative to the first component by screwing it into the internal thread or at least with the aid of this screw connection. The internal thread is assigned to an element that is different from the insert. This does not mean that the screw cannot also be screwed into an internal thread of the insert. However, there is at least one element other than the insert in the area of the first component into which the screw is screwed. For example, the internal thread of the element other than the insert is the only internal thread into which the screw is screwed. Alternatively, the internal thread is assigned to the insert.

The insert is fixed axially in the receptacle via a force-fit and/or form-fit connection on its lateral surface. This means that a force-fit and/or form-fit interface to another element is formed on the lateral surface of the insert.

The other element can be the first component. In this case, the interface is formed between the lateral surface of the insert and the surface of the first component that delimits the receptacle. Alternatively, it is also possible for the insert to be inserted into another element within the receptacle, for example, into another insert. In this case, the force-fit and/or form-fit interface is formed between the lateral surface and this other element. In particular, the other element is then fixed axially in the receptacle, for example, also via a force-fit and/or form-fit connection, so that the insert is also fixed axially in the receptacle overall.

The force-fit and/or form-fit connection on the lateral surface of the insert is a detachable connection. This means that the insert is not held in the receptacle by a material-fit connection. For example, the system is configured so that when the screw is removed, the axial position of the insert relative to the first and second components can be adjusted.

According to at least one embodiment, the insert has a coating on its lateral surface in order to fix the insert in the receptacle via the force-fit connection or adhesive bond.

The coating may consist of an elastic and/or plastically deformable material. It fulfils various functions, such as clamping, tensioning and/or damping and/or bonding purposes. Typical materials for this purpose are polyamide and/or other plastics, which may contain microencapsulated components, for example. The coating ensures that the insert can be fixed in the receptacle via a force-fit connection and/or can be bonded by activating an adhesive or curing mechanism based, for example, on radical, anionic or cationic polymerization, polyaddition, polycondensation or any other chemical reaction. This guarantees increased stability and reliable anti-rotation protection. In addition, the coating can help to dampen unwanted vibrations or noises.

According to at least one embodiment, the insert has a flange. The diameter of the flange is then greater than the diameter of the lateral surface, that is, the flange protrudes radially beyond the lateral surface. The diameter of the flange may be greater than the diameter of the receptacle of the first component and/or greater than the diameter of the feedthrough. The flange is arranged in particular outside the receptacle or at the opening to the receptacle. The flange may be arranged axially between the first and second components. The end face of the insert is formed, for example, by the flange.

According to at least one embodiment, a second insert is arranged in the hole of the first insert. In particular, the second insert is inserted into the first insert. The second insert is, for example, arranged at least partially or completely within the receptacle. The second insert may be formed in one piece. The second insert may be rotationally symmetrical with respect to the z-axis and/or cylindrical in shape. For example, the second insert is a sleeve or a bushing. The first insert and the second insert may be made of different materials. The first insert may be made of plastic and the second insert of metal, for example steel, or vice versa.

According to at least one embodiment, the second insert has the internal thread into which the screw is screwed. In particular, the second insert also includes a hole, for example in the form of a feedthrough or recess, into which the screw is screwed. The hole in the second insert is in particular rotationally symmetrical with respect to the z-axis and/or cylindrical.

The second insert can be screwed into the first insert. In this case, an internal thread is provided in the area of the hole in the first insert, and an external thread of the second insert is screwed into this internal thread.

By using two inserts, one inserted into the other, the axial position of the first insert can be specified independently of the screw connection in the second insert. This makes it particularly easy to use the first insert to bridge a gap between the first and second components, that is, as a tolerance compensation, without affecting the screw connection for the screw within the first component.

According to at least one embodiment, the first insert is radially deformable. In particular, the first insert can be radially expanded or enlarged.

According to at least one embodiment, the system is configured such that, when the screw is tightened, a tensile force acting on the second insert in the axial direction is at least partially converted into a force acting radially outward on the first insert. The force acting radially outward presses the lateral surface of the first insert against a surface facing the lateral surface.

Via the radially deformable first insert and the radially acting force exerted by the tightened screw, the lateral surface is pressed against an opposite surface. The first insert can thus be fixed axially by force closure or friction closure. For example, the connection or interface between the lateral surface and the surface facing the lateral surface is then a purely force-locked connection or interface.

Here and in the following, a tightened or secured screw is understood to mean that the screw is tightened or secured in accordance with its intended use. For example, the screw is tightened with a torque specified for the connection. The screw tightened in this way pulls the first insert toward the screw head so that the aforementioned tensile force acts on the first insert.

According to at least one embodiment, when the screw is tightened, the second insert is pressed in the axial direction against a stop inside the first insert. In particular, the second insert is pressed in the axial direction toward the screw head against the stop.

According to at least one embodiment, the stop has a stop surface extending radially and axially against which the second insert is pressed. The stop surface extending radially and axially allows the tensile force acting on the second insert to be partially converted into a force acting radially outward. The stop surface is, for example, a conical lateral surface or a conical surface inside the first insert. The stop may be part of the first insert, that is, it may be firmly connected to the rest of the first insert. Alternatively, the stop may be formed by a retaining element inserted into the first insert. For example, in the second case, the retaining element is pressed in the radial direction against the inner side of the first insert bordering the hole.

According to at least one embodiment, the first insert is slotted. Alternatively or additionally, the first insert includes or consists of plastic. For example, the plastic is rubber. In the case of a slotted insert, the slot extends in particular in the axial direction, for example over the entire axial length of the first insert. The first insert may have several slots arranged one behind the other in the azimuthal direction around the z-axis. The slotted configuration and/or the plastic configuration allows the first insert to be radially deformable.

According to at least one embodiment, the second insert is slotted. When the screw is tightened, a thread flank of the internal thread of the second insert strikes a thread flank of the screw and the second insert is spread radially outward. For example, the pitch of the thread flanks is between 10° and 80° inclusive or between 20° and 70° inclusive.

The slot extends in the second insert in particular through the internal thread of the second insert, thus interrupting the internal thread. For example, the second insert is slotted multiple times, thus including several slots arranged azimuthally one behind the other around the z-axis. The slots may extend completely through the second insert in the correct axial direction or only partially through it. The second insert is made of metal, for example. The first insert is made of plastic, in particular rubber, for example. The first insert may protrude into the slots in the second insert.

According to at least one embodiment, the second insert has a flange. The diameter of the flange of the second insert is, for example, larger than the diameter of the lateral surface of the first insert, that is, the flange of the second insert protrudes radially beyond the lateral surface of the first insert. The diameter of the flange may be larger than the diameter of the receptacle of the first component and/or larger than the diameter of the feedthrough. The flange of the second insert is arranged in particular outside the receptacle or at the opening to the receptacle. The flange can be arranged axially between the first and second components. An end face of the second insert facing the second component is formed, for example, by the flange. This end face can bear against the second component in the area around the feedthrough.

According to at least one embodiment, the first insert has an anti-twist protection on the lateral surface. The anti-twist protection is in positive engagement with a respective counterpart of the surface facing the lateral surface. This engagement prevents the first insert from rotating in the receptacle.

For example, the anti-twist protection is a projection on the lateral surface that engages in a recess in the surface facing the lateral surface. For example, the surface of the first component that defines the receptacle has the counterpart to the anti-twist protection.

According to at least one embodiment, an auxiliary element is further inserted into the first insert, that is, arranged in the hole in the first insert. The auxiliary element is, for example, a sleeve. The auxiliary element may have a flange which, for example, has a larger diameter than the lateral surface and/or than the receptacle and/or than the feedthrough. The flange of the auxiliary element is, for example, arranged axially between the first component and the second component. The flange of the auxiliary element forms, for example, an end face that faces the second component, in particular in the area around the feedthrough on the second component.

The auxiliary element is an element that is different from the second insert. It is arranged, for example, at least partially in the receptacle and can be arranged axially spaced apart from the second insert. The auxiliary element can be made of metal, for example steel. The auxiliary element itself can have a hole through which or into which the screw is guided. The surface of the auxiliary element bordering the hole is, for example, smooth, in particular free of an internal thread. For example, the auxiliary element is arranged axially between the second insert and the screw head.

According to at least one embodiment, the auxiliary element presses the first insert radially outward against the surface facing the lateral surface. In particular, the pressure exerted by the lateral surface on the surface facing the lateral surface forms a purely force-fit connection between the lateral surface and the surface facing the lateral surface, which is strong enough that the first insert is not twisted when the screw is unscrewed or screwed in.

According to at least one embodiment, the first insert has an external thread on its lateral surface, which is screwed into an internal thread on a surface facing the lateral surface. For example, the first component has an internal thread in the area of the receptacle, into which the external thread of the first insert is screwed. The axial position of the first insert can then be adjusted by a screwing movement, for example to bridge the distance between the first component and the second component. The screw connection of the screw can advantageously remain unaffected by this.

According to at least one embodiment, the flange of the first insert is arranged at the receptacle and rests against the first component with a surface extending transversely, in particular perpendicularly, to the lateral surface. For example, the surface of the flange rests completely around the receptacle on the first component. The flange can be arranged in a recess in the first component in the area around the opening, whereby the recess then has a larger diameter than the receptacle. Alternatively or additionally, a sealing ring can be arranged between the flange and the first component.

With such a flange, the first insert can protect the interior of the receptacle from moisture penetration and thus from corrosion. For example, the first component is a component containing magnesium and/or aluminum. For example, the first component consists of magnesium and/or aluminum. The first component may have a coating to protect the first component from corrosion. In the area of the receptacle, the coating is at least partially removed, for example by introducing an internal thread. Corrosion can easily occur in this area. The first insert with the flange can protect against moisture penetrating into this corrosion-prone area of the receptacle.

According to at least one embodiment, the first insert is made of a harder material than the first component. For example, the first insert is made of steel, in particular stainless steel. The first component may contain magnesium and/or aluminum or consist of these materials.

According to at least one embodiment, the thread pitch of the internal thread into which the screw is screwed is opposite to that of the external thread of the first insert. For example, the internal thread into which the screw is screwed is a right-hand thread and the external thread of the insert is a left-hand thread.

According to at least one embodiment, the internal thread into which the screw is screwed is part of the first component. This means that the screw is screwed directly into the first component.

According to at least one embodiment, a further insert, hereinafter also referred to as the "third insert," is screwed into the receptacle. In particular, the third insert has an external thread. For example, the external thread is screwed into an internal thread of the first component provided in the area of the receptacle.

The third insert is, for example, rotationally symmetrical with respect to the z-axis and/or cylindrical in shape. The third insert includes a hole, for example in the form of a recess or feedthrough. The hole is, for example, rotationally symmetrical with respect to the z-axis and/or cylindrical in shape. The third insert may be a sleeve.

According to at least one embodiment, the first insert is screwed into an internal thread of the third insert. In particular, the first insert is screwed into the hole in the third insert. The internal thread of the third insert is then formed in the area of the hole.

According to at least one embodiment, the third insert has the internal thread into which the screw is screwed. For example, the hole in the third insert has two sections with different diameters. The first insert is screwed into the section of the hole with the larger diameter, for example. The screw is then screwed into the area of the hole of the third insert with the smaller diameter, for example. The section of the hole with the larger diameter is located axially between the opening to the receptacle and the section of the hole with the smaller diameter, for example.

According to at least one embodiment, the third insert has a flange. The flange of the third insert protrudes radially beyond the external thread of the third insert. The diameter of the flange may be larger than the diameter of the receptacle of the first component and/or larger than the diameter of the feedthrough in the second component. The flange of the third insert is arranged in particular outside the receptacle or at the opening to the receptacle. The flange may be arranged axially between the first and second components. An end face of the third insert facing the second component is formed, for example, by the flange. This end face may abut the second component in the area around the feedthrough.

According to at least one embodiment, the flange of the third insert is arranged at the receptacle and rests against the first component with a surface extending transversely, in particular perpendicularly, to the lateral surface. For example, the surface of the flange rests completely around the receptacle on the first component. The flange of the third insert can be arranged in a recess in the first component in the area around the opening, whereby the recess then has a larger diameter than the receptacle. With such a flange, the third insert forms, for example, corrosion protection as described above.

Alternatively or additionally, a sealing ring may be arranged between the flange and the first component.

According to at least one embodiment, the insert has a tool interface for axially positioning the insert using a tool. The tool interface is, for example, an interface for an Allen key. The tool interface is provided, for example, at an axial end of the insert facing the second component.

Alternatively or additionally, the second insert and/or the third insert may also have such a tool interface. It is also possible for the tool interface to be provided at an axial end facing away from the second component.

According to at least one embodiment, the first component is a housing part for a motor housing of the bicycle. For example, the first component is an aluminum and/or magnesium housing for an electric motor of the bicycle.

According to at least one embodiment, the second component is a frame part for the frame of the bicycle. For example, the second component is the down tube or seat tube of the bicycle.

Next, the bicycle is specified. The bicycle is, in particular, an electric bicycle. The bicycle includes the system described herein.

Next, the compensating element is specified. The compensating element serves to bridge a gap between two components that are to be connected via a screw.

In at least one embodiment, the compensating element includes a first element and a second element. The first element is radially deformable. The second element has an internal thread for screwing in a screw. The second element is arranged in the first element. The compensating element is configured such that, when a screw is screwed into the internal thread of the second element and the first element is held in place, a tensile force exerted by the screw on the second element results in a radially outward force on the first element. Alternatively, the compensating element is configured such that, when the first element is applied, the compensating element can establish a force-fit connection and/or an adhesive bond with one of the components to be connected.

The compensating element may have a flange at one axial end. The flange may be formed by the first and/or second element.

The compensating element is configured to be inserted into a receptacle of a component, which can then be screwed to a second component. When the screw is screwed into the internal thread and tightened, the tensile force acting on the second element causes it to move axially relative to the first element, which is held in place. For example, the second element then hits a stop in the first element, causing a force acting radially outward to act on the second element. The second element is then radially deformed, in particular its diameter is increased. The radially outward force allows the compensating element to be axially fixed within the receptacle. In particular, the radially outward force results in a lateral surface of the first element being pressed against a surface in the receptacle, so that the receptacle element is fixed axially in the receptacle solely by force or friction. The first element is held in place during screwing in and tightening, for example, by an end face of the compensating element, which may be formed by the flange, striking against the second component in the axial direction.

Alternatively, the first element is a coating to fix the insert in the receptacle via a force-fit connection and/or an adhesive bond.

The compensating element described here can be used in particular to compensate for a tolerance in the axial distance between the two components and, at the same time, to reduce noise or wear on the components.

The first and second elements of the compensating element correspond, for example, to the respective first and second inserts described in connection with the system. In this respect, all features disclosed in connection with the system, in particular the features disclosed for the first and second inserts, are also disclosed for the compensating element and in particular for its first and second elements, and vice versa. In the system described above, for example, the compensating element described here is inserted into the receptacle of the first component.

Alternatively, the first element corresponds to the coating described in connection with the system and the second element corresponds to the insert described in connection with the system. In this respect, all features disclosed in connection with the system, in particular the features disclosed for the insert and for the coating, are also disclosed for the compensating element and in particular for its first and second elements, and vice versa. In the system described above, for example, the compensating element described here is inserted into the receptacle of the first component.

Next, the kit for connecting two components of a bicycle via a screw is specified. The kit includes a protective element with an external thread and an internal thread. The kit also includes an insert element with an external thread. The insert element can be inserted into the protective element and its external thread can be screwed into the internal thread of the protective element. The protective element and/or the insert element have an internal thread for screwing in the screw. The protective element also has a flange that protrudes radially beyond the external thread of the protective element.

Such a kit can be used in particular to provide corrosion protection for the first component in the area of the receptacle. The first component includes, for example, magnesium and/or aluminum or consists of these materials. The protective element and/or the insert element are made of steel, for example.

The protective element and the insert element are, in particular, two elements that can be handled separately from each other and can be inserted into each other and screwed together. The composite of the protective element and the insert element can then be inserted, for example, into a receptacle of a first component in order to then screw the first component to a second component.

In one embodiment, the protective element of the kit is the first insert described in connection with the system, and the insert element is the second insert described in connection with the system. In this respect, all features disclosed in connection with the system, in particular the features disclosed for the first and second inserts, are also disclosed for the kit and in particular for its protective element and insert element, and vice versa.

Alternatively, the protective element may also be the third insert described in connection with the system, and the insert element may be or have the first insert described in connection with the system. In this respect, all features disclosed in connection with the system, in particular the features disclosed for the third and first inserts, are also disclosed for the kit and in particular for its protective element and insert element, and vice versa.

According to at least one embodiment, the insert element is the compensating element described here.

Next, the method for connecting two components for a bicycle is specified. The method is used, for example, to manufacture the system described herein. In this respect, all features disclosed in connection with the system are also disclosed for the method and vice versa.

In at least one embodiment, the method includes providing a first component with a receptacle and providing a second component with a feedthrough. Furthermore, the method includes providing the compensating element described herein and/or the kit described herein. Subsequently, the compensating element is inserted into the receptacle and/or the protective element is inserted into the receptacle. If the insert element is not yet inserted into the protective element, the insert element is inserted into the protective element after the protective element has been inserted into the receptacle. In a further step, a screw is passed through the feedthrough and screwed into the internal thread of the second element or screwed into the internal thread of the protective element or into the internal thread of the insert element.

### BRIEF DESCRIPTION OF DRAWINGS

The invention will now be described with reference to the drawings wherein:

FIG. 1 shows an embodiment of a bicycle;

FIG. 2 shows an embodiment of the counterbalance element;

FIG. 3 shows a position in an embodiment of the method;

FIG. 4 shows an embodiment of the system;

FIG. 5 shows another embodiment of the compensating element;

FIG. 6 shows a position in a further embodiment of the method;

FIG. 7 shows another embodiment of the system;

FIG. 8 shows another embodiment of the compensating element;

FIG. 9 shows a position in another embodiment of the method;

FIG. 10 shows another embodiment of the system;

FIG. 11 shows another embodiment of the compensating element;

FIG. 12 shows a position in another embodiment of the method;

FIG. 13 shows another embodiment of the system;

FIG. 14 shows a detailed view of FIG. 13;

FIG. 15 shows a position in another embodiment of the method;

FIG. 16 shows another embodiment of the system;

FIG. 17 shows another embodiment of the inlet;

FIG. 18 shows another embodiment of the system;

FIG. 19 shows a position in another embodiment of the method;

FIG. 20 shows another embodiment of the system;

FIG. 21 shows yet another embodiment of the system; and,

FIG. 22 shows an embodiment of the kit.

### DETAILED DESCRIPTION

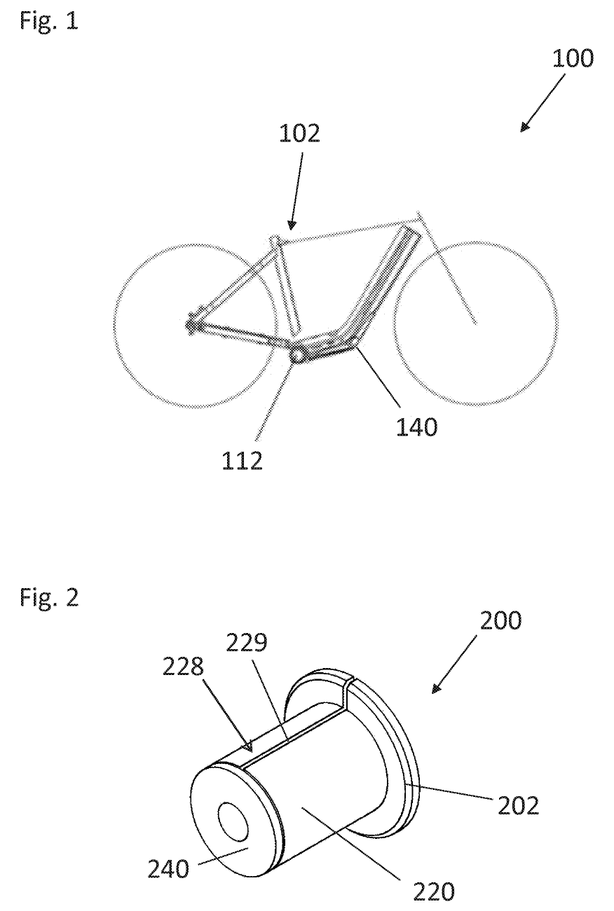

FIG. 1 schematically shows an electric bicycle 100 with a bicycle frame 102, which includes a lower frame section 140 that forms a down tube. The frame section 140 extends toward a bottom bracket that includes a pedal shaft 112. An electric motor for propelling the electric bicycle 100 is provided in the area of the bottom bracket. The electric motor is bolted to the down tube 140.

FIG. 2 shows an embodiment of a compensating element 200 in a perspective view. This compensating element 200 can be used, for example, for the connection of the electric motor to the bicycle frame in FIG. 1. The compensating element 200 includes a first element 220 or a first insert 220 with a cylindrical hole. The hole extends axially through the entire length of the first insert 220, thus forming a feedthrough. The first insert 220 is a sleeve in this case. The compensating element 200 further includes a second element 240 or a second insert 240, which is inserted into the hole in the first insert 220. The second insert 240 is, for example, a bushing or sleeve. The second insert 240 includes a hole in the form of a feedthrough for inserting a screw. For example, the first insert 220 consists of a plastic, such as rubber, and the second insert 240 consists of a metal.

The first insert 220 has a slotted, cylindrical lateral surface 228. The slit 229 runs in an axial direction and extends over the entire length of the first insert 220. At one axial end, the compensating element 200 has a flange 202 formed by the first insert 220, the diameter of which is greater than the diameter of the lateral surface 228.

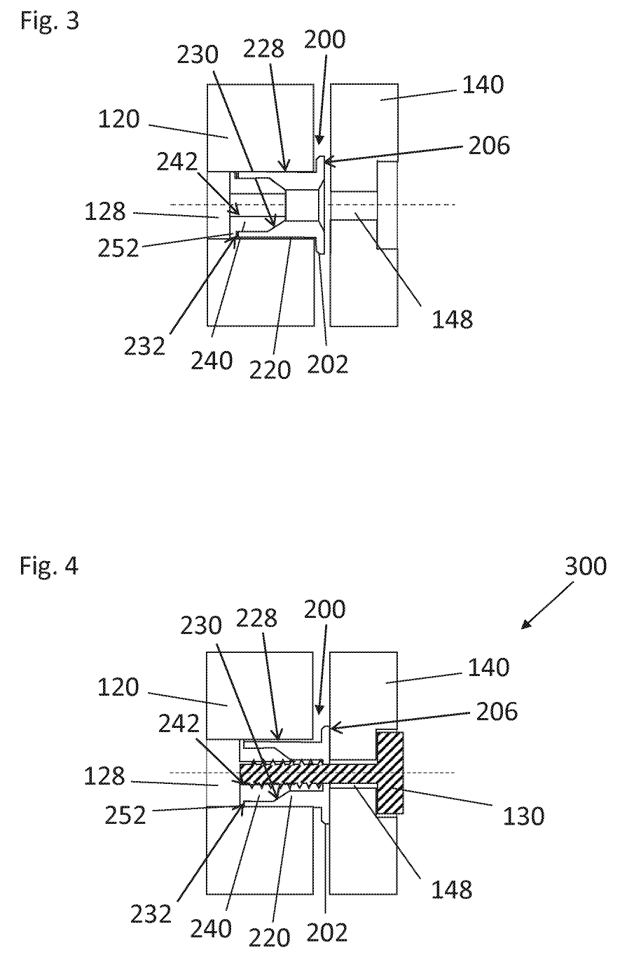

FIG. 3 shows a cross-sectional view of a position of the method in which the compensating element 200 of FIG. 2 is inserted into a receptacle 128 of a first component 120. The first component is, for example, the housing of the electric motor of FIG. 1. The housing 120 is made of magnesium or aluminum, for example. A second component 140, for example the frame section 140 shown in FIG. 1, includes a feedthrough 148 that is arranged in alignment or coaxially with the receptacle 128 of the first component 120. The flange 202 is arranged axially between the first component 120 and the second component 140 in the area of a gap between the first component 120 and the second component 140. The flange 202 has a larger diameter than the receptacle 128 and than the feedthrough 148.

As can be seen in FIG. 3, a stop 230 is provided inside the first insert 220, which forms a conical or funnel-shaped or conical stop surface. The second insert 240 has a conical surface parallel to it, which faces the stop surface. Furthermore, the second insert 240 includes an internal thread 242 in the area of the hole. The internal thread 242 is provided for screwing in a screw. The first insert 220 does not have an internal thread.

Furthermore, it can be seen in FIG. 3 that the second insert 240 has a further flange 252 at the axial end facing away from the flange 202. The first insert 220 has an end face 232 facing this flange 252 and forming a stop for the flange 252.

FIG. 4 shows a position in the process after a screw 130 has been passed through the feedthrough 148 and screwed into the second insert 240. When tightening the screw 130, the second insert 240 was pulled in the axial direction toward the screw head of the screw 130. The first insert 220 can only move with it until an end face of the flange 202 strikes the second component 140. The second insert 240 is then moved relative to the first insert 220 in the direction of the second component 140. However, this relative movement is also limited by the stop 252 hitting the end face 232. However, the axial relative movement has been sufficient to convert part of the axial tensile force exerted by the screw 130 into a force acting radially outward on the first insert 220 by the conical surfaces inside the first insert 220 striking against the end face 232. This radial force caused the first insert 220 to be radially spread or stretched, thereby pressing its lateral surface 228 in the radial direction against the surface of the first component 120 that limits the receptacle 128. The maximum pressure force applied in this process is limited by the fact that the stop 252 eventually strikes the end face 232. In any case, the compensating element 200 is configured so that the radially acting compressive force is large enough to create a force-fit connection between the lateral surface 228 and the surface of the first component 120 bordering the receptacle 128, which is strong enough to fix the receptacle element 220 axially in the receptacle 128.

As can be seen in FIG. 4, the spacer element 200 bridges the axial distance between the first component 120 and the second component 140. FIG. 4 also shows an embodiment of the system 300.

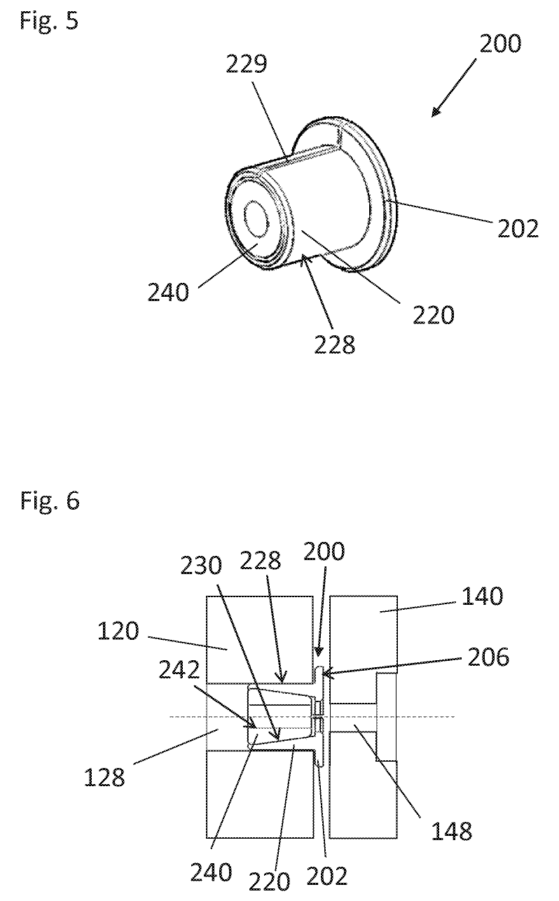

FIG. 5 shows another embodiment of the spacer element 200. In the perspective view shown, this spacer element 200 looks like the spacer element 200 in FIG. 2.

FIG. 6 shows a position in an embodiment of the method in which the compensating element 200 of FIG. 5 is inserted into the receptacle 128 of the first component 120. The sectional view shown in FIG. 6 clearly shows the difference between the compensating element 200 of FIG. 5 and the compensating element of FIG. 2. Here, the entire lateral surface of the second insert 240 is conical. In addition, due to a defined fit of the second insert 240 in the first insert 220, even without a screw being inserted, an axial force is exerted on the second insert 240, which presses the conical surfaces against each other, thereby exerting a predetermined, radially outward force on the first insert 220. This predetermined force (compressive stress) establishes a force-fit connection between the lateral surface 228 and the surface of the first component 120 facing the lateral surface 228, which is sufficiently strong to prevent the first insert 220 from rotating within the receptacle 128 when the screw is screwed in.

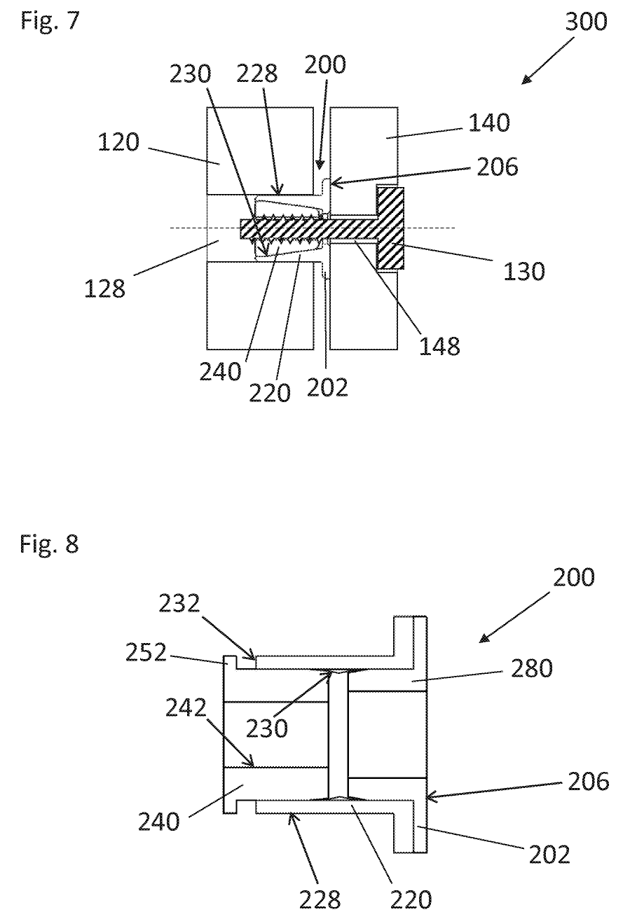

FIG. 7 shows a position in the process after screwing in a screw 130 and, at the same time, an embodiment of the system 300. Screwing in the screw 130 caused the compensating element 200 to be displaced axially again and pressed against the second component 140 with the end face 206 of the flange 202. In addition, tightening the screw 130 pressed the second insert 240 even more strongly against the stop surface of the stop 230, thereby exerting an even greater radial outward force on the first insert 220. The resulting expansion of the first insert 220 re-establishes a force-fit connection on the lateral surface 228, which fixes the compensating element 200 axially within the receptacle 128.

FIG. 8 shows another embodiment of the compensating element 200, which is similar to the compensating element of FIGS. 2 to 4. Here, too, a stop 230 with a conical stop surface is provided inside the first insert 220, against which the second insert 240 can strike. In addition, a sleeve-shaped auxiliary element 280 is inserted into the hole of the first insert 220.

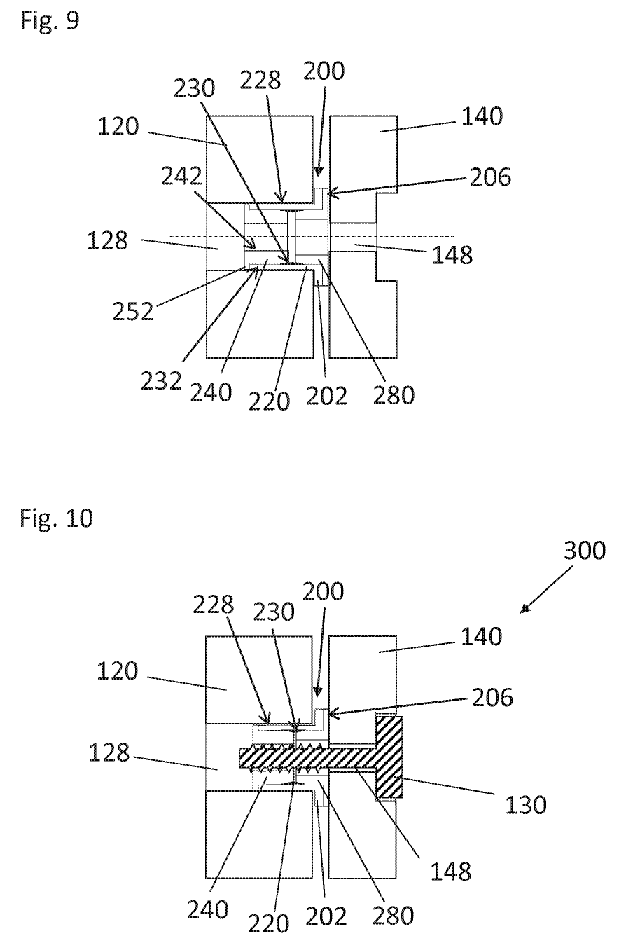

FIG. 9 shows a position in an embodiment of the method in which the compensating element 200 of FIG. 8 is inserted into the receptacle 128 of the first component 120. The auxiliary element 280 exerts a radially outward force on the first insert 220, thereby establishing a force-fit connection to the first component 120 on the lateral surface 228. This force-fit connection is sufficient to prevent the first insert 220 from twisting when a screw is screwed in.

FIG. 10 shows a position in the process after a screw 130 has been screwed in. At the same time, FIG. 10 shows an embodiment of the system 300. Screwing in the screw 130 caused the second insert 240 to shift axially relative to the first insert 220 again. By striking the conical stop surface 230, the first insert 220 was further spread radially, thereby strengthening the force-fit connection on the lateral surface 228 and achieving axial fixation of the compensating element 220 within the receptacle 128.

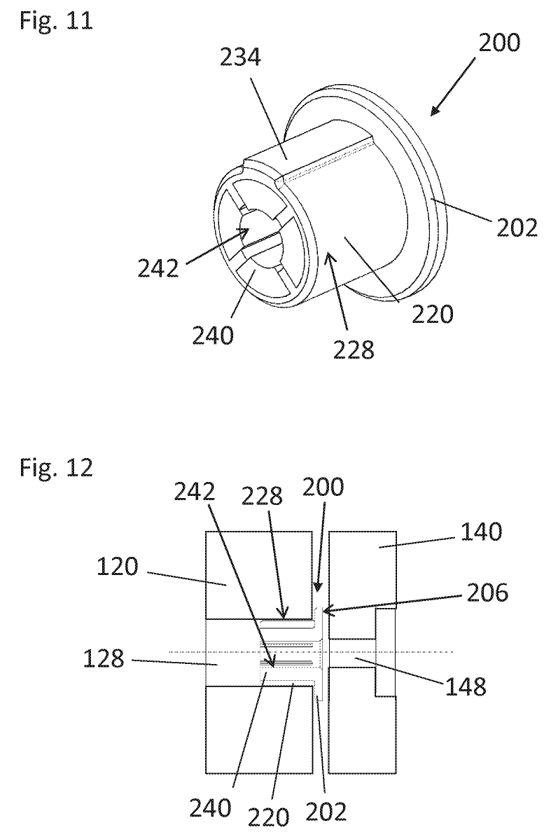

FIG. 11 shows an embodiment of the compensating element 200 in which the first insert 220 is not slotted. Instead, the second insert 240 is slotted multiple times. The slits in the second insert 240 interrupt the internal thread 242 of the second insert 240. In addition, the second insert 240 forms the flange of the compensating element 200.

An anti-twist protection 234 in the form of a projection is provided on the lateral surface 228 of the first insert 220. This projection can engage in a respective recess in the first component 120 to prevent the compensating element 200 from twisting when the screw is screwed in.

FIG. 12 shows a position in an embodiment of the method in which the compensating element 200 of FIG. 11 is inserted into the receptacle 128 of the first component 120.

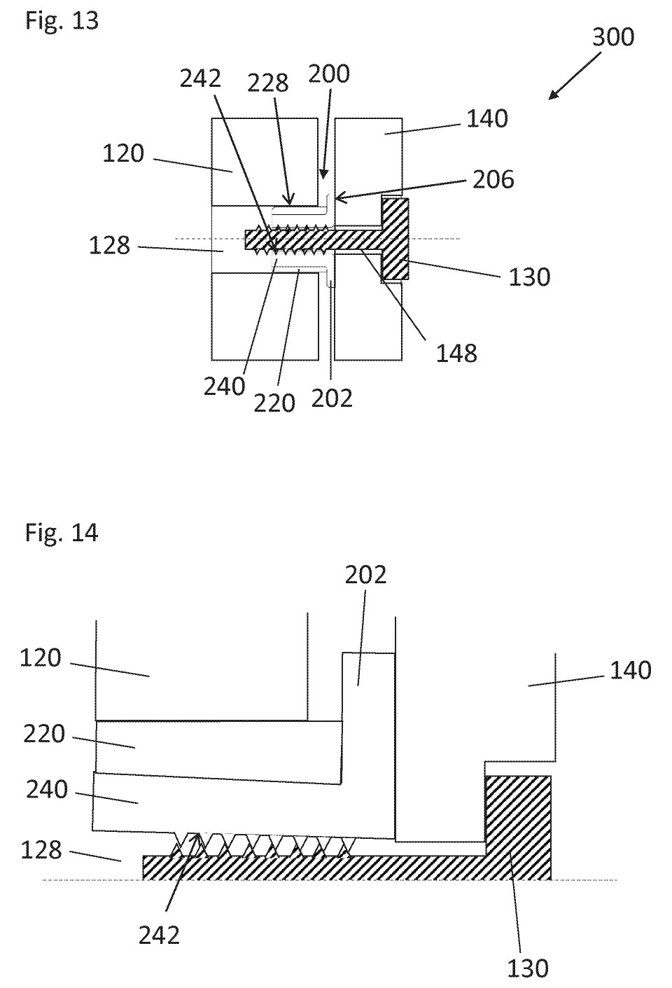

FIG. 13 shows a position after a screw 130 has been screwed into the compensating element 200. At the same time, FIG. 13 shows another embodiment of the system 300. When the screw 130 is tightened, the thread flanks of the internal thread 242 of the second insert 240 and the thread flanks of the screw 130 strike against each other. This can be seen more clearly in the detailed view in FIG. 14. This contact causes the slotted second insert 240 to spread radially, pressing the first insert 220 with its lateral surface 128 against the first component 120. In this way, the compensating element 200 is fixed axially in the receptacle 128.

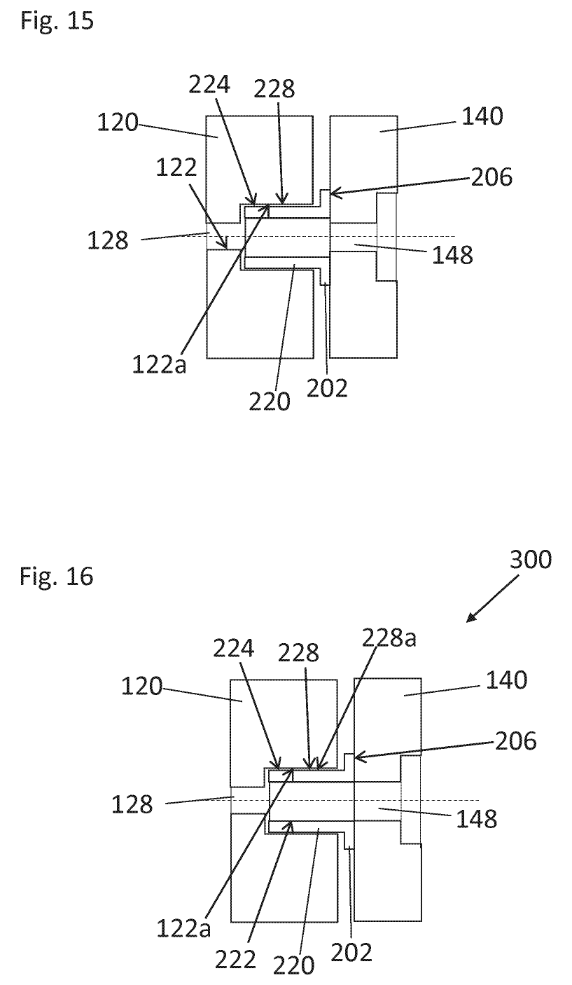

FIG. 15 shows a position in an embodiment of the method in which a first insert 220 is inserted into the receptacle 128 of the first component 120. The first insert 220 is again formed here as a sleeve with a flange which is arranged axially between the first component 120 and the second component 140. The first insert 220 has no internal thread. The receptacle 128, on the other hand, has an internal thread 122. In the area of this internal thread 122, the receptacle 128 is, for example, narrower or has a smaller diameter than in the area into which the first insert 220 is inserted.

In the present case, the first insert 220 also has an external thread 224 on its lateral surface 228, which is screwed into an internal thread 122a of the first component 120. The internal thread 122a is provided in the area of the receptacle 128 with the larger diameter. By screwing the first insert 220 into the internal thread 122a of the first component 120, the first insert 120 can be fixed axially in the receptacle 128 and its axial position can be precisely adjusted.

FIG. 16 shows a position in an embodiment of the method in which the insert 220 is inserted into the receptacle 128 of the first component 120. FIG. 16 also shows another embodiment of the system 300. Here, the insert 220 is again formed as a sleeve with a flange that is arranged axially between the first component 120 and the second component 140. The insert 220 includes, in particular, an internal thread 222 via which the screw (not shown) can be screwed in. The receptacle 128 in particular does not have an internal thread. In a rear area of the receptacle 128, for example, it is narrower or has a smaller diameter than in an area in which the insert 220 is inserted.

In the present case, the insert 220 also has an external thread 224 on its lateral surface 228, which is screwed into an internal thread 122a of the first component 120. The internal thread 122a is provided in the area of the receptacle 128 with the larger diameter. By screwing the insert 220 into the internal thread 122a of the first component 120, the first insert 120 can be fixed axially in the receptacle 128 and its axial position can be precisely adjusted.

Alternatively, the insert 220 may also have no external thread 224 and the first component 120 may have no internal thread 122a.

A coating 229 is also applied to the lateral surface 228. This coating 229 allows the insert 202 to be fixed in the receptacle 128 via a force-fit connection and/or an adhesive bond. In addition, the coating 229 can be used to provide anti-rotation protection.

The coating 229 may consist of an elastic and/or plastically deformable material. It fulfils various functions, such as clamping, tensioning and/or damping and/or bonding purposes. Typical materials for this are polyamide and/or other plastics, which may contain microencapsulated components, for example. In particular, the coating 229 ensures that the insert 220 can be fixed in place in receptacle 128 via a force-fit and/or can be bonded by activating an adhesive or curing mechanism based, for example, on radical, anionic or cationic polymerization, polyaddition, polycondensation or any other chemical reaction. This guarantees increased stability and reliable anti-rotation protection. In addition, coating 229 can help to dampen unwanted vibrations or noises.

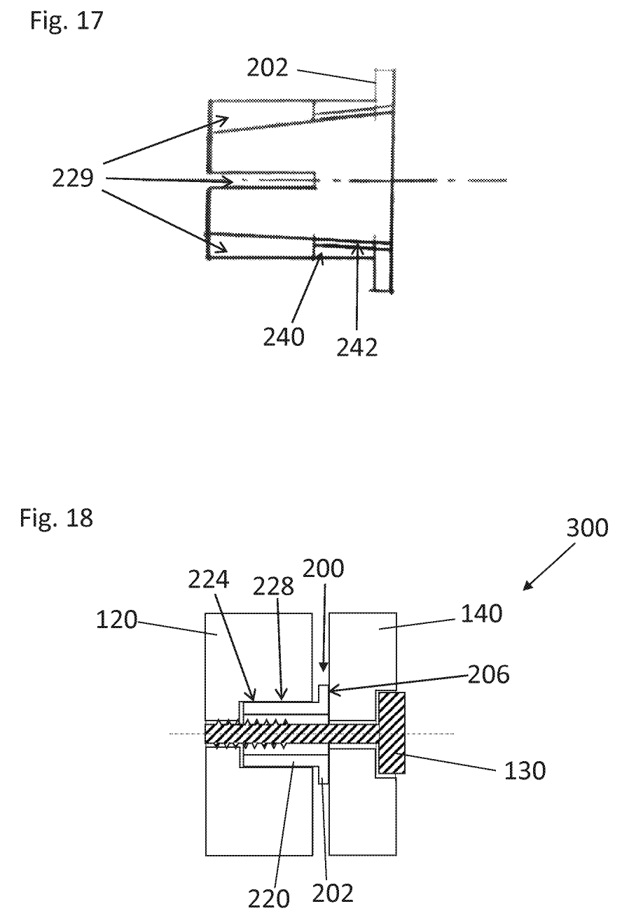

FIG. 17 shows another embodiment of the second insert 240. Alternatively, the figure may also show a single insert similar to FIG. 16, which has an insert and a coating. The second insert 240 is formed as a sleeve with a flange 202. The second insert 240 includes, in particular, a conical internal thread 242, via which the screw (not shown) can be screwed in. The second insert 240 further has several axial slots 229 which extend over part of the outer surface of the second insert 240. Due to the slots 229 and the conical shape of the internal thread 242, the slotted area of the second insert 240 expands radially when the screw is screwed in, so that it can be fixed in the receptacle.

FIG. 18 shows a position after a screw 130 has been inserted through the first insert 220 and screwed into the internal thread 122 of the first component 120. When screwing the screw 130 into the internal thread 122, the axial position of the first insert 220 relative to the first component 120 can remain unaffected. FIG. 18 also shows an embodiment of the system 300.

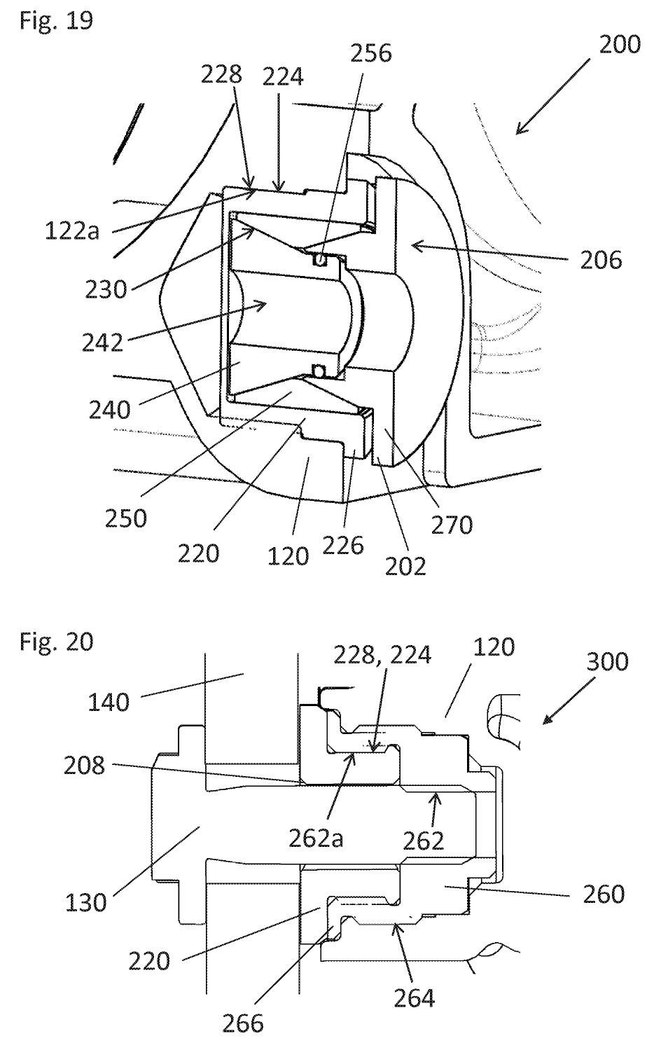

FIG. 19 shows a position in an embodiment of the method in which a second insert 240 is inserted into the receptacle 128 of the first component 120. As before, the compensating element 200 here includes the first insert 120, in which a hole is formed. The second insert 240 is inserted into the hole. The second insert 240 again includes a conical lateral surface and the internal thread 242 for screwing in the screw.

Unlike in the previous embodiments, however, the first insert 220 is not radially deformable here. Instead, the first insert 22 consists, for example, of a metal such as stainless steel. The first insert 220 also has an external thread 224 on its lateral surface 228, which is screwed into an internal thread 122a of the first component 120.

A retaining element 250 is provided inside the first insert 220 next to the second insert 240. The retaining element 250 is annular and includes conical surfaces, so that, when viewed in cross-section, the lateral surface of the retaining element 250 is V-shaped. One of these conical surfaces runs parallel to the conical lateral surface of the second insert 240. A washer 270 is also inserted into the first insert 220, which has a conical lateral surface in the area of the first insert 220. The securing element 250 is arranged axially between the conical lateral surfaces of the second insert 240 and the washer 270. The washer 270 also forms an end face 206 for striking against the second component.

By using two conical surfaces between which the securing element 250 is arranged, when a screw is screwed into the internal thread 242, the two elements 240 and 270 can clamp the securing element 250 between them and thereby press it radially outward against the inside of the first insert 220. This allows a particularly good distribution of force to be achieved.

In the embodiment of the spacer element 200 shown in FIG. 19, the first insert 220 also forms a protective element against corrosion of the internal thread 122a. The first insert 220 has a flange 226. A surface of this flange 226 extending perpendicular to the lateral surface 228 rests against the receptacle 128 on the first component 120, preferably all around the receptacle 128. This prevents or suppresses moisture from penetrating into the area between the first insert 220 and the first component 120. This is particularly advantageous if the first component 120 is made of magnesium. In the area of the internal thread 122a, a protective coating on the magnesium is usually removed, making this area particularly susceptible to corrosion. In this respect, the first insert 220 with its flange 226 provides corrosion protection.

FIG. 20 shows another embodiment of the system 300, in which an embodiment of the kit is inserted into the receptacle of the first component 120. Here, the kit includes a protective element 260 or an insert 260 with an external thread 264 and an internal thread 262a. The external thread 264 is screwed into an internal thread of the first component 120. An insert element 220 or an insert 220 with a lateral surface 228 and an external thread 224 on the lateral surface 228 is screwed into the internal thread 262a of the protective element 260. The insert 220 has a feedthrough into which a screw 130 is inserted. A tool interface 208 is formed at one axial end of the feedthrough, with which the insert 220 can be screwed out of the protective element 260 or further into the protective element 260.

The protective element 260 has a further internal thread 262 into which the screw 130 is screwed, thereby connecting the first component 120 to the second component 140. The internal thread 262 has a smaller diameter than the internal thread 262a.

As can be seen in FIG. 20, the protective element 260 has a flange 266 which is arranged at the receptacle for receiving the first component 120. More precisely, the flange 266 is recessed in a depression in the first component 120. The flange 266 rests against the first component 120 with a surface pointing in the axial direction, namely around the receptacle. This reduces the probability of liquid reaching the internal thread of the first component 120, as shown in FIG. 19. Here too, the protective element 260 provides corrosion protection. The insert element 220 also has a flange that rests on the flange 266 and covers it in a top view of the receptacle, for example completely covering it.

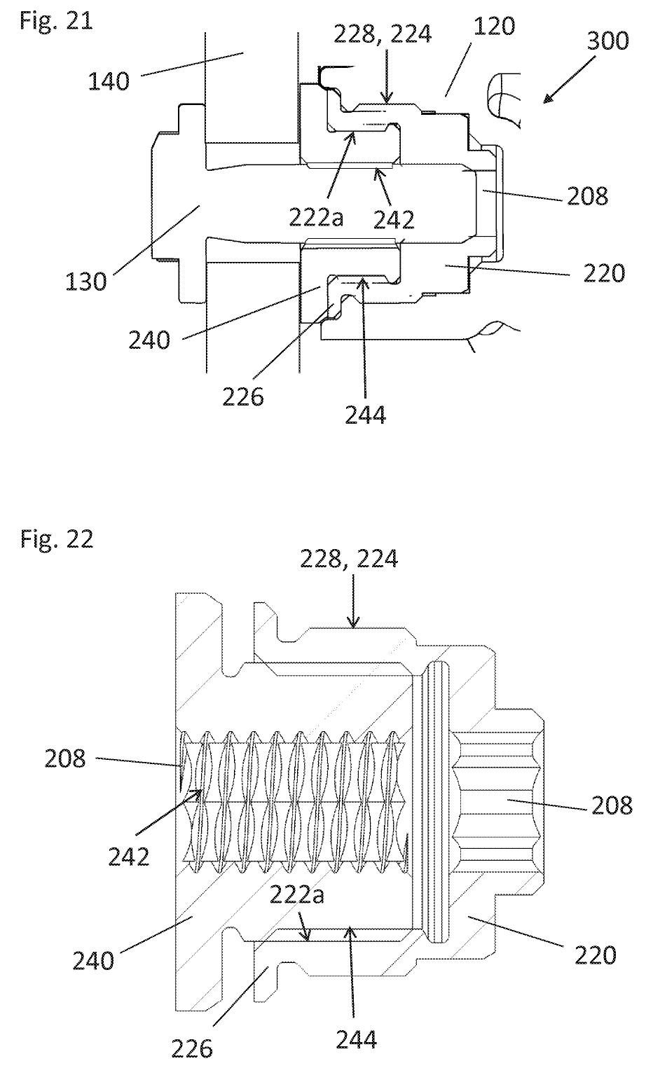

FIG. 21 shows another embodiment of the system 300. This is similar to that of FIG. 20. Here, however, the insert element 240 or the insert 240 has the internal thread 242 into which the screw 130 is screwed, and not the protective element 220. The insert element 240 has an external thread 244 and is thus screwed into an internal thread 222a of the protective element 220 or the insert 220. The protective element 220 also has an external thread 224 on its lateral surface 228 and is thus screwed into the receptacle of the first component 120. Here too, the protective element 220 has a flange 226 which rests against the opening for the receptacle in the axial direction. With regard to its function as corrosion protection, the same applies as for the flange 266 in FIG. 21. The insert element 240 also has a flange that rests on the flange 226 and covers it in a top view of the opening for the receptacle, for example completely covering it.

FIG. 22 shows an embodiment of the kit. The kit is similar to that shown in FIG. 21. The internal thread 242 can be seen here, as no screw has been screwed in yet. The insert element 240 is already screwed into the protective element 220. In addition, as in FIG. 21, the tool interface 208 is provided at the axial end of the protective element 220 facing away from the flange 226.

It is understood that the foregoing description is that of the preferred embodiments of the invention and that various changes and modifications may be made thereto without departing from the spirit and scope of the invention as defined in the appended claims.

### List of reference symbols

100 Bicycle

102 Bicycle frame

112 Pedal shaft

140 Frame section

120 First component

122 Internal thread

122a Internal thread

128 Receptacle

130 Screw

140 Second component

148 Feedthrough

132 Internal thread

134 Internal thread

200 Compensating element

202 Flange

206 End face

208 Tool interface

220 (first) insert / insert element / protective element

222 Internal thread

222a Internal thread

224 External thread

226 Flange

228 Lateral surface

229 Slot

230 Stop

232 Stop

234 Anti-twist protection

240 Second insert / insert element

242 Internal thread

244 External thread

250 Locking element

252 Flange

256 Sealing ring

260 Additional/third insert/protective element

262 Internal thread

262a Internal thread

264 External thread

266 Flange

270 Washer

280 Auxiliary element

300 System

1. A system for a bicycle, the bicycle comprising:
a first component and a second component connected to each other via a screw;
said first component having a receptacle;
said second component having a feedthrough;
an insert with a hole being inserted into said receptacle;
said screw being guided through said feedthrough into said hole in said insert and being screwed into an internal thread of an element other than said insert in an area of said first component; and,
said insert having a lateral surface extending around said hole and being fixed axially in said receptacle via at least one of a force-fit and a form-fit connection on said lateral surface.

2. The system of claim 1, wherein said insert has a coating on said lateral surface in order to fix said insert in said receptacle via said force-fit connection or an adhesive bond.

3. The system of claim 1, wherein said insert is a first insert, the system further comprising:
a second insert arranged in said hole of said first insert; and,
said second insert having said internal thread into which said screw is screwed.

4. The system of claim 3, wherein:
said first insert is radially deformable; and,
the system is configured such that, when said screw is tightened, a tensile force acting on said second insert in an axial direction is at least partially converted into a force acting radially outward on said first insert, which presses said lateral surface against a surface facing said lateral surface.

5. The system of claim 3, wherein:
when said screw is tightened, said second insert is pressed in an axial direction against a stop inside said first insert; and,
said stop has a stop surface extending radially and axially against which said second insert is pressed.

6. The system of claim 1, wherein at least one of:
said insert includes or consists of plastic; and,
said insert is slotted.

7. The system of claim 3, wherein:
said second insert is slotted; and,
when said screw is tightened, a thread flank of said internal thread of said second insert strikes a thread flank of said screw and said second insert is spread radially outward.

8. The system of claim 3, wherein said first insert has an anti-twist protection on said lateral surface that is in positive engagement with a respective counterpart of a surface facing said lateral surface, whereby this engagement prevents rotation of said first insert in said receptacle.

9. The system of claim 4 further comprising:
an auxiliary element being inserted into said first insert; and,
said auxiliary element pressing said first insert radially outward against a surface facing said lateral surface.

10. The system of claim 1, wherein said insert has an external thread on said lateral surface, which is screwed into an internal thread of a surface facing said lateral surface.

11. The system of claim 1, wherein said insert has a flange which is arranged at said receptacle and rests against said first component with a surface extending transversely to said lateral surface.

12. The system of claim 10, wherein a thread pitch of said internal thread into which said screw is screwed is opposite to that of said external thread of said insert.

13. The system of claim 10, wherein said internal thread into which said screw is screwed is part of said first component.

14. The system of claim 10 further comprising:
a further insert screwed into said receptacle;
said insert being screwed into an internal thread of said further insert; and,
said further insert having said internal thread into which said screw is screwed.

15. The system of claim 14, wherein said further insert has a flange which is arranged at an opening to said receptacle and rests against said first component with a surface extending transversely to said lateral surface.

16. The system of claim 1, wherein said insert has a tool interface for axially positioning said insert using a tool.

17. The system of claim 1, wherein:
said first component is a housing part for a motor housing of the bicycle; and,
said second component is a frame part for a frame of the bicycle.

18. A compensating element for bridging a gap between two components of a bicycle to be connected to each other via a screw, the compensating element comprising:
a radially deformable first element;
a second element with an internal thread for screwing in the screw;
said second element being arranged in said first element;
wherein:
the compensating element is configured such that, when the screw is screwed into said internal thread of said second element and said first element is held in place, a tensile force exerted by the screw on said second element results in a radially outward force on said first element; or,
the compensating element is configured such that, when said first element is applied, the compensating element is configured to establish a force-fit connection or an adhesive connection with one of the two components of the bicycle to be connected.

19. A kit for connecting two components of a bicycle via a screw, the kit comprising:
a protective element with a first external thread and an internal thread;
an insert element with a second external thread;
said insert element being configured to be inserted into said protective element and said second external thread being configured to be screwed into said internal thread of said protective element;
at least one of said protective element and said insert element having a second internal thread for screwing in the screw; and,
said protective element having a flange which protrudes radially beyond said first external thread of said protective element.

20. A method for connecting two components for a bicycle, the method comprising:
providing a first component having a receptacle;
providing a second component having a feedthrough;
providing a compensating element having a radially deformable first element and a second element with an internal thread for screwing in a screw, wherein the second element is arranged in the first element, and wherein:
the compensating element is configured such that, when the screw is screwed into said internal thread of said second element and said first element is held in place, a tensile force exerted by the screw on said second element results in a radially outward force on said first element; or,
the compensating element is configured such that, when said first element is applied, the compensating element is configured to establish a force-fit connection or an adhesive connection with one of the two components of the bicycle to be connected;
inserting the compensating element into the receptacle or inserting a protective element into the receptacle and, if an insert element is not yet inserted into the protective element, inserting the insert element into the protective element;
inserting a screw through the feedthrough; and,
screwing the screw into the internal thread of the second element of the compensating element or screwing the screw into an internal thread of the protective element or an internal thread of the insert element.
